(19) United States
(12) Patent Application Publication
(10) Pub. No.: US 2008/0236781 A1
(43) Pub. Date: Oct. 2, 2008

(54) Heat Exchanger, Particularly a Charge-Air Cooler for Motor Vehicles

(75) Inventors: Daniel Hendrix, Stuttgart (DE); Joachim Kopp, Stuttgart (DE); Jurgen Wegner, Eislingen/Fils (DE)

Correspondence Address: FOLEY AND LARDNER LLP;SUITE 500, 3000 K STREET NW, WASHINGTON, DC, 20007, US

(73) Assignee: Ebehr GmbH & Co. Kg

(21) Appl. No.: 11/571,360

(22) PCT Filed: Jun. 28, 2005
(86) PCT No.: PCT/EP05/06938

§ 371 Date: Jan. 9, 2008

(30) Foreign Application Priority Data
Jun. 29, 2004 (DE) 10 2004 031 566.3

(51) Int. Cl. B60H 1/00

(52) U.S. Cl. 165/41

(57) ABSTRACT

The invention relates to a heat exchanger, particularly a charge-air cooler for motor vehicles, comprised of a heat exchanger block (1), which is formed by flat tubes (2) and corrugated fins (3), and of collecting receptacles that communicate with the flat tubes (2). The flat tubes (2) can be flowed through by a medium to be cooled, and the corrugated fins (3) can be flowed around by ambient air. The invention provides that the flat tubes (2) are arranged in a row and have a depth T, which is measured in the direction of air flow L and which ranges from 70≦T≦120 mm.

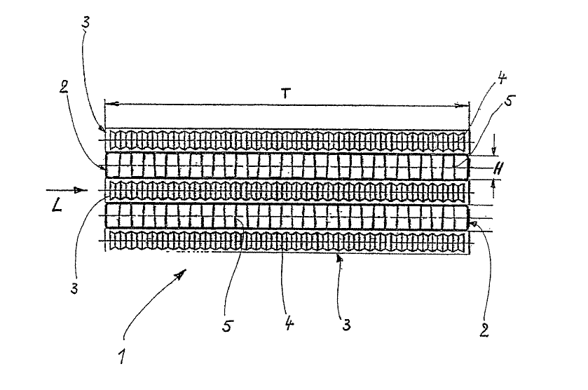

The invention relates to a heat exchanger, particularly a charge-air cooler for motor vehicles, according to the preamble of patent claim 1.

Known heat exchangers consist of a heat exchanger block (also called a network) and of headers arranged on both sides for the inlet and outlet or collection and distribution of a heat transfer medium, e.g. cooling medium or charge air. The heat exchanger block consists of tubes arranged parallel to one another, e.g. flat tubes, and of fins which increase the heat transfer area on the outer side of the tubes and over which ambient air flows. In the case of flat tubes, corrugated fins are used, which are brazed to the tubes. Arranged on the inner side of the tubes, in particular in the case of flat tubes, for improving the heat transfer are “inner corrugated fins” or “turbulence generators”, which are likewise brazed to the tube. This results in a robust combination, resistant to internal pressure, for the heat exchanger block. The tubes open with their tube ends into tube plates, which are parts of the headers or are connected to the headers. The tube plates have rim holes, in which the tube ends are brazed. A similar heat exchanger has been disclosed by DE-A 198 57 435.

Depending on the capacity of the heat exchanger, single- or multi-row systems (heat exchanger blocks) are used, i.e. one or more tube rows, separated by an air gap, are arranged one behind the other in the flow direction of the cooling air. In particular in the case of air-cooled charge-air coolers for cooling the combustion air of internal combustion engines for motor vehicles, single-row networks are used at lower capacities and two-row networks are used at higher capacities, the latter, to be precise, at overall depths of more than about 70 mm. Two-row systems have various disadvantages: they are both more expensive in production and have a poorer capacity. For the production, two rows of tubes with a continuous fin must be formed into a cassette and must be inserted into two rows of rim holes in the tube plates. For production reasons, the rim holes in the tube plates must be at a minimum distance apart in the depth direction, this distance also predetermining the distance apart of the tube rows in the network. This air gap increases the pressure drop on the cooling-air side and increases the overall depth of the heat exchanger.

The object of the invention is to improve a heat exchanger of the type mentioned at the beginning with regard to its production costs and its thermodynamic capacity.

The solution of this object is obtained from the features of patent claim 1. According to the invention, provision is made for the heat exchanger block to have only one row of flat tubes having a depth T which is greater than 70 mm and less than 120 mm. A single-row heat exchanger, particularly a charge-air cooler having such a depth in the flow direction of the cooling air, brings both production and cost advantages and advantages in capacity. Known heat exchangers, particularly charge-air coolers, have been designed with two rows at this depth. In contrast, the system according to the invention requires only one row of flat tubes, a continuous corrugated fin on the cooling-air side and an inner corrugated fin on the charge-air side. Such a system can be formed into a cassette in a substantially simpler manner than a two-row system. In addition, the tube plates have only one row of rim holes, i.e. the gaps between the rim holes in the cooling-air flow direction and between the tube rows are dispensed with. The additional advantage of a smaller overall depth and of a lower pressure drop on the primary and the secondary side is thus also obtained.

According to an advantageous development of the invention, the depth of the flat tubes is within a range of 70 to 100 mm, and in an especially advantageous manner within a range of 80 to 90 mm.

According to a further design of the invention, the depth of the flat tubes is within a range of 90 to 120 mm, and in an especially advantageous manner within a range of 90 to 100 mm.

According to an advantageous development of the invention, the flat tubes have a clear width within a range of between 3 and 10 mm, preferably between 5 and 10 mm, in particular within a range of 6 to 8 mm, the optimum being at a clear width of 7 mm. For such a cross section of the flat tubes, increased capacities are obtained for the heat exchanger.

According to a further advantageous configuration of the invention, inner corrugated fins or turbulence generators are arranged in the flat tubes and are brazed to the latter. This achieves the advantage of better heat transfer and increased resistance to internal pressure for the flat tubes, which is necessary in particular at an increased depth.

An exemplary embodiment of the invention is shown in the drawing and described in more detail below.

The single FIGURE shows a detail of a heat exchanger block 1 which is composed of one row of flat tubes 2 and corrugated fins 3 arranged between said flat tubes 2. The flat tubes 2 and corrugated fins 3 are part of a charge-air cooler (not shown) which cools the air (charge air) of a supercharged internal combustion engine (not shown) of a motor vehicle by ambient air (cooling air). The charge air flows through the flat tubes 2 perpendicularly to the drawing plane, and the ambient or cooling air flows in the direction of the arrow L between the flat tubes 2 over the corrugated fins 3, which are provided with gills 4 for improving the heat transfer. Arranged inside the flat tubes 2 are inner corrugated fins 5, which subdivide the cross section of the flat tubes 2 into a multiplicity of chambers and are brazed to the flat tubes 2 on their inner side. On the other hand, the corrugated fins 4 are brazed to the outer side of the flat tubes 2. In this respect, good conduction of heat from the inner side of the flat tubes 2 to their outer side is obtained. As explained at the beginning with regard to the prior art, the flat tubes 2 are held in rim holes (not shown) of tube plates and are brazed to the latter. Headers (not shown), what are referred to as air boxes, are mounted on the tube plates.

The overall depth, i.e. the extent of the flat tubes 2 and of the corrugated fins 3 in the air flow direction L, is designated by T. Although the dimension T is essential for the flat tubes 2, the corrugated fins 3 may have a slightly smaller or larger size, i.e. they may be set back relative to the narrow sides of the flat tubes 2 or may project beyond the latter. The clear width of the flat tubes 2 is identified by the dimension H. For a preferred embodiment of the flat tubes 2, the dimension T is within a narrower range of 80 to 90 mm, within a wider range of 70 to 100 mm and within a wide range of 70 to 120 mm. The flat tubes 2 are preferably produced from aluminum sheet and are welded at the narrow side in the longitudinal direction. The corrugated fins 3 (cooling-air fins) and the inner corrugated fins 5 (charge-air fins) are produced from thin aluminum sheet and are brazed to the flat tubes 2. This produces a compact heat exchanger block 1 which is stable under pressure.

1. A heat exchanger, particularly a charge-air cooler for motor vehicles, consisting of a heat exchanger block, formed by flat tubes and corrugated fins, and of headers communicating with the flat tubes, it being possible for a medium which is to be cooled to flow through the flat tubes and for ambient air to flow over the corrugated fins, wherein the flat tubes are arranged in one row (single row) and have a depth T measured in the air flow direction L, and in that the depth is within a range of 70≦T≦120 mm.

2. The heat exchanger as claimed in claim 1, wherein the depth is within a range of 70≦T≦100 mm.

3. The heat exchanger as claimed in claim 1, wherein the depth is within a range of 80≦T≦90 mm.

4. The heat exchanger as claimed in claim 1, wherein the depth is within a range of 90≦T≦120 mm.

5. The heat exchanger as claimed in claim 1, wherein the flat tubes have a clear width H (transversely to the air flow direction L) which is within a range of 3≦H≦10 mm.

6. The heat exchanger as claimed in claim 5, wherein the clear width is within a range of 6≦H≦8 mm, in particular around H=7 mm.

7. The heat exchanger as claimed in claim 1, wherein inner corrugated fins are arranged in the flat tubes (2).

8. The heat exchanger as claimed in claim 1, wherein the heat exchanger block is produced and brazed from aluminum materials.
